(19) United States
(12) Patent Application Publication
(10) Pub. No.: US 2024/0398105 A1
(43) Pub. Date: Dec. 5, 2024

(54) HYBRID ELECTRIC TOOTHBRUSH

(71) Applicant: SM LNS CO., LTD., Seoul (KR)

(72) Inventor: Seung-Mo LIM, Gyeonggi-do (KR)

(21) Appl. No.: 18/732,705

(22) Filed: Jun. 4, 2024

(30) Foreign Application Priority Data
Jun. 5, 2023 (KR) 10-2023-0072078

(51) Int. Cl. A46B 15/00; A61C 17/20; A61C 17/22; A61C 17/34

(52) U.S. Cl. CPC A46B 15/0026; A46B 15/0022; A61C 17/20; A61C 17/221; A61C 17/224; A61C 17/3481

(57) ABSTRACT

A hybrid electric toothbrush includes: a toothbrush body (100) having an internal space; a toothbrush head (200) vibrating while being coupled to the upper portion of the toothbrush body (100) to generate microcurrents; a hybrid providing part (300) built into the toothbrush body (100) and transmitting vibration to the toothbrush head (200) to form a magnetic field; and a toothbrush cradle (400) docking the toothbrush body (100) to store the toothbrush body (100) and providing charging power to the hybrid providing part (300).

### BACKGROUND

The present invention relates to a hybrid electric toothbrush which can remove food particles trapped in teeth by vibrating a toothbrush head and also remove plaque by forming a magnetic field.

In general, to maintain healthy teeth, proper brushing habits are essential. A good method of brushing involves holding the brush stationary on the gums and then moving from the gums to the teeth while brushing.

However, such brushing is not only time-consuming but also difficult to repeat with uniform motions.

The background art of the present invention is disclosed in Korean Patent No. 10-1056274 (Aug. 4, 2011).

### SUMMARY OF THE INVENTION

Accordingly, the present invention has been made to solve the above-mentioned problems occurring in the prior arts, and it is an objective of the present invention to provide a hybrid electric toothbrush which can remove food particles trapped in teeth by vibrating a toothbrush head and also remove plaque by forming a magnetic field.

To accomplish the above object, according to the present invention, there is provided a hybrid electric toothbrush including: a toothbrush body having an internal space; a toothbrush head vibrating while being coupled to the upper portion of the toothbrush body to generate microcurrents; a hybrid providing part built into the toothbrush body and transmitting vibration to the toothbrush head to form a magnetic field; and a toothbrush cradle docking the toothbrush body to store the toothbrush body and providing charging power to the hybrid providing part.

Preferably, the toothbrush head includes a plug, which is installed at the lower portion thereof, and to which the hybrid providing part is connected. The plug includes a through-groove into which the hybrid providing part is inserted and fixed, the toothbrush head includes: a ground electrode connected to a negative pole through the hybrid providing part; and an electrode spaced from the ground electrode and connected to a positive pole through the hybrid providing part to generate a magnetic field, wherein the ground electrode is connected to a negative terminal connected to the negative pole of the hybrid providing part, the electrode is connected to a positive terminal connected to the positive pole of the hybrid providing part, and the negative terminal and the positive terminal are spaced apart from each other and fixed to the plug, and then are exposed through the through-groove.

Preferably, the hybrid providing part includes: a sonic motor generating ultrasonic vibration using input power; a vibration shaft transmitting the vibration of the sonic motor; a shaft connection part formed on the sonic motor to which the vibration shaft is connected; a waterproof tube sealing between the vibration shaft and the shaft connection part watertightly; a battery suppling power to the sonic motor; a bracket embedded in the toothbrush body in the state in which the sonic motor and the battery are installed; a charging coil charging the battery with power provided by the toothbrush cradle; and a control unit controlling the sonic motor, controlling the charging of the charging coil, and controlling the charging power of the battery to form a magnetic field on the toothbrush head.

Preferably, the bracket has locking wings formed at both sides thereof and inserted into the toothbrush body to be caught to the toothbrush body, the lower portion of the toothbrush body is blocked by a cap, and the cap has supports formed on both sides thereof to support the locking wings of the bracket.

Preferably, the locking wings have locking jaws, the supports have locking grooves caught to the locking jaws, and when the cap blocks the toothbrush body in a state in which the locking jaws are caught to the locking grooves, the bracket is mounted on the toothbrush body.

Preferably, the toothbrush cradle includes: a toothbrush cradle body having an internal space opened upwards; a toothbrush cradle cover closing the internal space of the toothbrush cradle body and holding the toothbrush body placed thereon; a charging unit supplying charging power to the hybrid providing part embedded in the toothbrush body; and a power cable supplying external power to the charging unit.

Preferably, the toothbrush cradle cover has a concave mounting groove, an inclined surface getting narrower towards the lower portion thereof, and a flat bottom surface formed under the inclined surface.

As described above, according to the present invention, the hybrid electric toothbrush can remove food particles trapped in teeth by vibrating the toothbrush head and also remove plaque by forming a magnetic field.

### BRIEF DESCRIPTION OF THE DRAWINGS

FIG. 1 is a perspective view of a hybrid electric toothbrush according to an embodiment of the present invention.

FIG. 2 is a perspective view of the rear of the present invention.

FIG. 3 is an exploded perspective view of a toothbrush body of the present invention.

FIG. 4 is an exploded perspective view of a toothbrush head of the present invention.

FIG. 5 is a view illustrating terminals which provide microcurrent included in the toothbrush head of the present invention.

FIG. 6 is an exploded perspective view of a hybrid providing part of the present invention.

FIG. 7 is a photograph showing a state where the hybrid providing part is coupled to the toothbrush body of the present invention.

FIG. 8 is an exploded perspective view illustrating a bracket applied to ultrasonic emission of the present invention.

FIG. 9 is an exploded perspective view of a toothbrush cradle of the present invention.

### DETAILED DESCRIPTION OF THE PREFERRED EMBODIMENT

Hereinafter, the present invention will be described in detail with reference to the accompanying drawings.

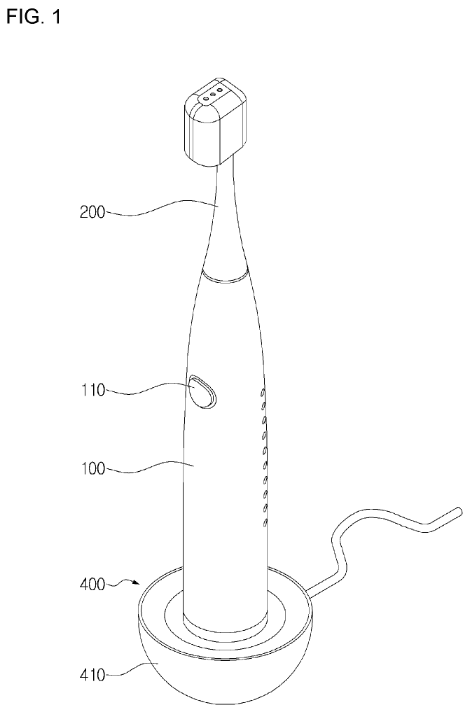

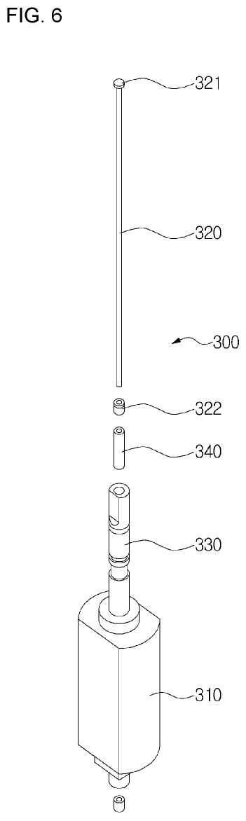

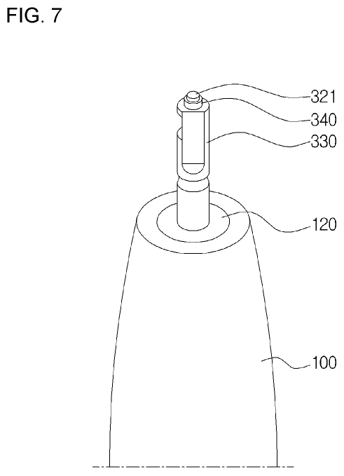

As illustrated in FIGS. 1 and 6, a hybrid electric toothbrush according to an embodiment of the present invention includes: a toothbrush body 100 having an internal space; a toothbrush head 200 vibrating while being coupled to the upper portion of the toothbrush body 100 to generate microcurrents; a hybrid providing part 300 built into the toothbrush body 100 and transmitting vibration to the toothbrush head 200 to form a magnetic field; and a toothbrush cradle 400 docking the toothbrush body 100 to store the toothbrush body 100 and providing charging power to the hybrid providing part 300.

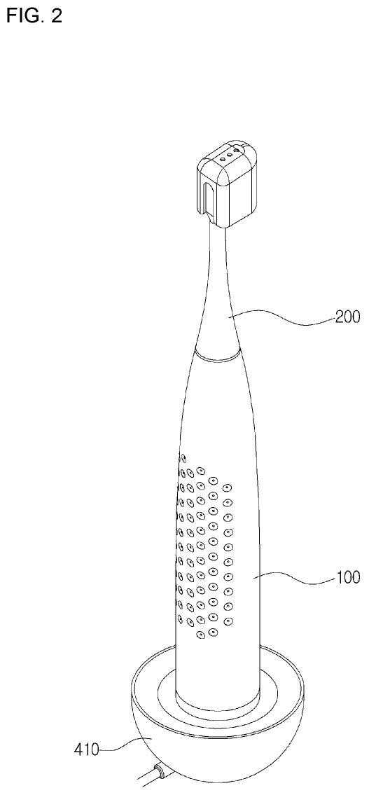

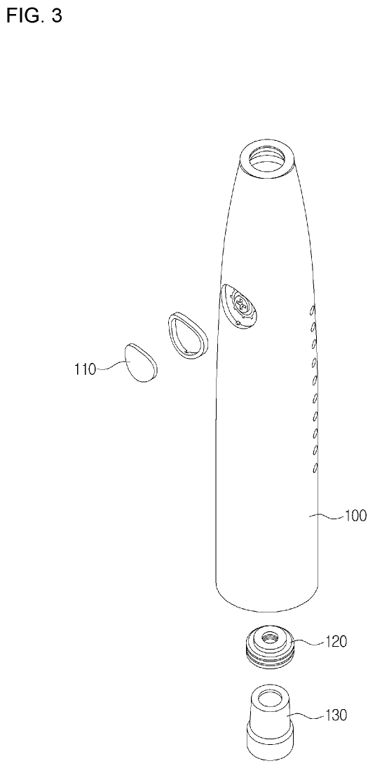

As illustrated in FIGS. 1 to 3, the toothbrush body 100 is formed in a cylindrical shape for user grip, gets narrower towards the top, and may have a plurality of protrusions or wrinkles on the outer surface thereof to prevent a user's hand from slipping. The toothbrush body 100 has an internal space which is vertically penetrated for accommodating the hybrid providing part 300 built therein. A switch 110 is formed on the toothbrush body 100 to be exposed to the outside, enabling the operation or stopping of the hybrid providing part 300. The switch 110 is electrically connected to the hybrid providing part 300 to operate the hybrid providing part 300. That is, when the user operates the switch 110 while holding the toothbrush body 100, the hybrid providing part 300 is activated, allowing the user to automatically brush the user's teeth. The switch 110 is installed on the toothbrush body 100 with a packing around the switch 110, thereby preventing moisture ingress around the switch 110.

The toothbrush body 100 further includes a waterproof ring 120 which is installed within the toothbrush 100 to seal the upper portion thereof watertightly, and a shaft bracket 130 which is supported by the waterproof ring 120 and supports a shaft connection part 330 of the hybrid providing part 300. The toothbrush body 100 has an inward ledge formed at the upper portion, such that the outside of the waterproof ring 120 is caught to the inward ledge.

The waterproof ring 120 is made of a highly watertight rubber material, and has a hole formed inside through which the shaft connection part 330 of the hybrid providing part 300 passes, and a male thread formed on the outside thereof to be screw-coupled with a female thread formed inside the toothbrush body 100. Alternatively, to enhance the watertightness of the waterproof ring 120, wrinkles may be formed.

The shaft bracket 130 has a hole formed inside for the shaft connection part 330 of the hybrid providing part 300 to pass through and a flange formed on the outside. The shaft bracket 130 is inserted into the interior of the toothbrush body 100 and forcibly inserted into the toothbrush body 100 to press the waterproof ring 120, and then, the flange of the outside is forcibly inserted and fixed into the toothbrush body 100.

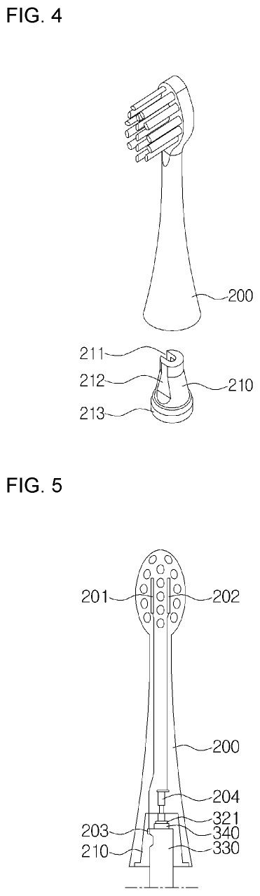

As illustrated in FIG. 4, the toothbrush head 200 is formed in a tapered shape getting wider from top to bottom, and has bristles formed on the upper portion thereof and a plug 210 installed at the lower portion thereof for connection to the hybrid providing part 300.

The plug 210 transmits vibration generated by the hybrid providing part 300 to the toothbrush head 200, and has a through-groove 211 formed for insertion and fixation of the hybrid providing part 300, and fixing surfaces 212 formed on both sides thereof to be inserted and fixed into the toothbrush head 200.

The through-groove 211 is formed in a ‘U’ shape in cross section. The shaft connection part 330 of the hybrid providing part 300 is forcibly inserted and fixed into the through-groove 211. During the forced insertion of the plug 210 into the lower portion of the toothbrush head 200, the through-groove 211 shrinks for easy insertion of the plug 210, and once the plug 210 is inserted, the through-groove 211 expands, such that the fixing surfaces 212 are supported and fixed on both sides inside the toothbrush head 200. That is, the state where the plug 210 is inserted and fixed into the toothbrush head 200 can be maintained firmly.

The plug 210 has a finishing flange 213 which is finished by being in contact with the lower portion of the toothbrush head 200. That is, the plug 210 is not inserted into the toothbrush head 200 by the finishing flange 213. Furthermore, the finishing flange 213 can prevent moisture from penetrating into the interior of the toothbrush head 200.

The plug 210 transmits the vibration generated by the hybrid providing part 300 to the toothbrush head 200, causing the bristles of the toothbrush head 200 to vibrate and clean the teeth.

Additionally, as illustrated in FIG. 5, the toothbrush head 200 includes: a ground electrode 201 connected to a negative pole through the hybrid providing part 300; and an electrode 202 spaced from the ground electrode 201 and connected to a positive pole through the hybrid providing part 300 to generate a magnetic field.

The ground electrode 201 is connected to a negative terminal 203 connected to the negative pole of the hybrid providing part 300, and the electrode 202 is connected to a positive terminal 204 connected to the positive pole of the hybrid providing part 300. The negative terminal 203 and the positive terminal 204 are spaced apart from each other and fixed to the plug 210, and then are exposed through the through-groove 211. In this instance, when the shaft connection part 330 is inserted into the through-groove 211 of the plug 210, the shaft connection part 330 is connected to the negative terminal 203, and a vibration weight 321 protruding upward from the shaft connection part 330 is connected to the positive terminal 204.

Therefore, when the hybrid providing part 300 controls a battery 350 to supply charging power, a magnetic field induced by alternating current or direct current is generated between the ground electrode 201 and the electrode 202. That is, an electric field is provided in the oral cavity to make it difficult for oral biofilms (plaque, dental plaque) to form and loosen the structure of the already formed biofilms, thereby removing the biofilms or breaking binding of the biofilms.

As described above, the toothbrush head 200, which vibrates approximately 40,000 times per minute, can remove food particles and tartar stuck between the teeth. Simultaneously, the toothbrush head 200 can also remove plaque by the magnetic field formed on the toothbrush head 200.

As illustrated in FIGS. 4 to 6, the hybrid providing part 300 includes: a sonic motor 310 generating ultrasonic vibration using input power; a vibration shaft 320 transmitting the vibration of the sonic motor 310; a shaft connection part 330 formed on the sonic motor 310 to which the vibration shaft 320 is connected; a waterproof tube 340 sealing between the vibration shaft 320 and the shaft connection part 330 watertightly; a battery 350 suppling power to the sonic motor 310; a bracket 360 embedded in the toothbrush body 100 in the state in which the sonic motor 310 and the battery 350 are installed; a charging coil 370 charging the battery 350 with power provided by the toothbrush cradle 400; and a control unit 380 controlling the sonic motor 310, controlling the charging of the charging coil 370, and controlling the charging power of the battery 350 to form a magnetic field on the toothbrush head 200.

The sonic motor 310 includes piezoelectric elements which are twisted in response to electrical input. When electricity is applied to the piezoelectric elements, the piezoelectric elements are repeatedly twisted and generate frequencies corresponding to ultrasound. Then, vibration by the frequencies corresponding to the ultrasound is transmitted to the vibration shaft 320.

The vibration shaft 320 has the bottom of which is inserted and embedded into the shaft connection part 330, and the vibration weight 321 is formed on the top of the vibration shaft 320. The ultrasonic vibration generated by the sonic motor 310 is concentrated in the vibration weight 321 through the vibration shaft 320. Moreover, the vibration concentrated on the vibration weight 321 is transmitted to the toothbrush head 200.

The vibration shaft 320 is made of a metal which has electricity and conducts electricity, thereby transmitting the vibration generated by the sonic motor 310 to the toothbrush head 200.

The vibration shaft 320 has a cable plug 322, which is installed at the bottom of the vibration shaft 320 and is a conductor through which power flows. The cable plug 322 is electrically connected to the positive side of the battery 350 via a cable or similar means.

The shaft connection part 330 is formed in a rectangular column shape so that the shaft connection part 330 is inserted into the plug 210 of the toothbrush head 200 and both sides are supported in the through-groove 211 of the plug 210. The shaft connection part 330 has a hole penetrated vertically such that the vibration shaft 320 is inserted into the hole and the vibration weight 321 is caught and fixed to the top of the shaft connection part 330.

The shaft connection part 330 is made of a conductive metal, and the negative side of the battery 350 is electrically connected to the shaft connection part 330.

The waterproof tube 340 is made of silicone and is inserted into the hole of the shaft connection part 330 with the vibration weight 321 inserted, ensuring a waterproof seal. That is, the waterproof tube 340 seals between the vibration weight 321 of the vibration shaft 320 and the shaft connection part 330 watertightly to prevent moisture infiltration. As illustrated in FIG. 6, the vibration weight 321 protrudes from the top of the shaft connection part 330 while being wrapped by the waterproof tube 340.

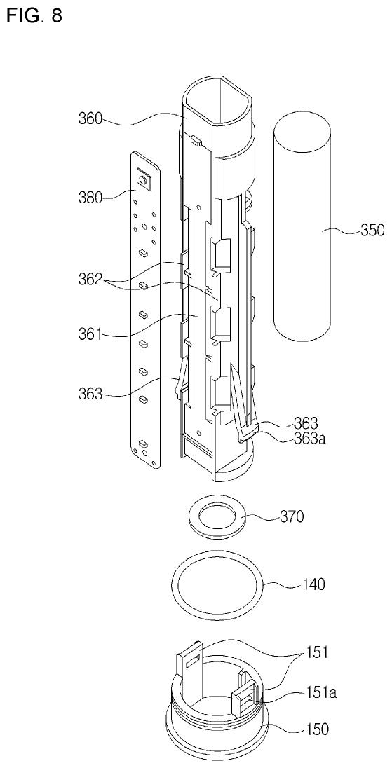

As illustrated in FIG. 8, the battery 350 is a lithium battery, which is charged and supplies power to the sonic motor 310.

The bracket 360 has an internal space which is open top to bottom, such that the sonic motor 310 is embedded at the top and the battery 350 is embedded at the bottom. A mounting groove 361 is formed in one side of the bracket 360, and the control unit 380 is inserted and mounted into the mounting groove 361. Elastic jaws 362 are formed on both sides of the mounting groove 361, such that both sides of the control unit 380 are elastically supported.

The bracket 360 has locking wings 363 formed on both sides thereof. The locking wings 363 are formed to be elastically deformable, so when external pressure is applied, the locking wings 363 are folded, and when external pressure is removed, the locking wings 363 are spread.

The charging coil 370 charges the battery 350 with power provided from the toothbrush cradle 400. The charging coil 370 receives electrical energy from the magnetic field created by the alternating current generated from the toothbrush cradle 400 while being connected to the battery 350, and charges the battery 350. Accordingly, the wireless charging of the battery 350 is achieved.

The control unit 380 includes a circuit board, which has a chip, such as a programmed CPU, and electronic components equipped thereon, to operate or stop the sonic motor 310 by recognizing the operation of switch 110, charge the battery 350 through the charging coil 370 with the power provided by the toothbrush cradle 400, and provide the charging power of the battery 350 to the toothbrush head 200.

Furthermore, the control unit 380 makes current flow from the electrode 202 to the ground electrode 201 during the positive half-cycle, and makes current flow from the electrode 202 to the ground electrode 201 during the negative half-cycle, such that the current alternates. Alternatively, the control unit 380 may include an AC converter which converts the direct current supplied from the battery 350 into alternating current.

Here, the control unit 380 must be set to apply alternating electrical current of appropriate amplitude and frequency to provide an effective and safe electrical effect during brushing and apply direct current of intensity that does not cause electrolytic reactions between the electrodes. That is, preferably, the amplitude of the alternating current ranges from ±0.01 V to ±3.0 V, and the frequency ranges from 0.1 kHz to 100 MHz.

Additionally, the control unit 380 applies negative current to the ground electrode 201 and applies positive current to the electrode 202. At this time, it is preferable to set the direct current to generate direct current signal having an electric field potential difference ranging from −0.85 V to 0.85 V/cm. More specifically, it is preferable to apply a current and an electric field that have the level of body current below the level of tens of mA so that the human body cannot notice electricity, but are effective enough to remove biofilms (plaque). In more detail, it is preferable to apply a current and an electric field that have the level of body current below tens to thousands of mA so that the human body cannot notice electricity, but are applicable to remove biofilms (plaque).

Of course, the control unit 380 can also be set to form an electric field by either alternating current (AC) or direct current (DC).

As described above, the control unit 380 can be configured to provide both the vibration and the magnetic field to the toothbrush head 200 together or separately.

The lower portion of the toothbrush body 100 is sealed by a waterproof ring 140 and a cap 150. The waterproof ring 140 prevents moisture ingress, and the cap 150 prevents the bracket 360 from being separated from the toothbrush body 100.

The cap 150 has supports 151 formed on both sides thereof to support the locking wings 363 of the bracket 360. Thus, when the locking wings 363 are supported by the supports 151, the bracket 360 is embedded in the toothbrush body 100 while the cap 150 blocks the toothbrush body 100.

The locking wings 363 have locking jaws 363a, and the supports 151 have locking grooves 151a caught to the locking jaws 363a. When the cap 150 blocks the toothbrush body 100 in a state in which the locking jaws 363a are caught to the locking grooves 151a, the bracket 360 is mounted on the toothbrush body 100. Additionally, when the cap 150 is separated from the toothbrush body 100, the bracket 360 is also separated. Of course, the sonic motor 310 and the battery 350 embedded in the bracket 360 can be also separated from the toothbrush body 100.

The cap 150 includes an accommodation groove 362 in which the charging coil 370 is accommodated. When the charging coil 370 is accommodated in the accommodation groove 362, the charging coil 370 is not exposed externally to be protected. Once the locking jaw 363a is caught to the locking groove 151a, the bracket 360 is fixed to the cap 150, thus the charging coil 370 gets in contact with the battery 350, and then, is fixed.

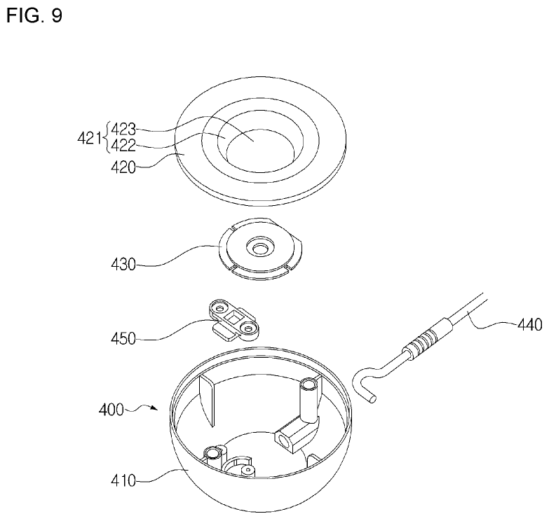

As illustrated in FIG. 9, the toothbrush cradle 400 includes: a toothbrush cradle body 410 having an internal space opened upwards; a toothbrush cradle cover 420 closing the internal space of the toothbrush cradle body 410 and holding the toothbrush body 100 placed thereon; a charging unit 430 supplying charging power to the hybrid providing part 300 embedded in the toothbrush body 100; and a power cable 440 supplying external power to the charging unit 430.

The toothbrush cradle body 410 is formed in a shape that gets narrower from the top to the bottom, so the bottom of the toothbrush cradle body 410 can be minimized in contact area with the ground. A USB line card 450 electrically connected to the charging unit 430 may be embedded in the toothbrush cradle body 410.

The toothbrush cradle cover 420 has a concave mounting groove 421, an inclined surface 422 getting narrower towards the lower portion thereof, and a flat bottom surface 423 formed under the inclined surface 422. That is, when the toothbrush body 100 is inserted into the mounting groove 421, which has the cross section getting narrower towards the lower portion thereof, the bottom of the toothbrush body 100 moves downwards along the inclined surface 422 and is supported by the flat bottom surface 423, thereby being positioned upright to be stored.

The diameter of the bottom surface 423 of the mounting groove 421 may be the same as the toothbrush body 100. That is, the lower circumference of the toothbrush body 100 is supported by the circumference of the bottom surface 423 of the mounting groove 421, causing the toothbrush body 100 to stand upright. At this time, the bottom of the toothbrush body 100 is in surface contact with the bottom surface 423 of the mounting groove 421, allowing the toothbrush body 100 to remain continuously in a vertical and upright position.

The charging unit 430 includes a coil for forming a magnetic field, and a PCB providing alternating current to the coil. The PCB converts the applied commercial power into alternating current to supply to the coil.

The power cable 440 is connected to the USB line card 450 to apply commercial power. The applied commercial power can be supplied to the charging unit 430 through the USB line card 450.

As described above, when the user operates the switch 110 while holding the toothbrush body 100, the hybrid providing part 300 is activated to transmit vibration to the toothbrush head 200. In this instance, when the user contacts the toothbrush head 200 with the teeth, brushing is performed by vibrations occurring approximately 40,000 times per minute.

After completing the brushing, when the user operates the switch 110, the hybrid providing part 300 stops, and the transmission of vibration is also stopped. Subsequently, when the toothbrush body 100 is placed on the toothbrush cradle 400, the battery 350 is automatically charged.

As described above, according to the present invention, since the hybrid electric toothbrush can remove food particles trapped in teeth by vibrating the toothbrush head and also remove plaque by forming the magnetic field, the present invention is very useful.

Those skilled in the art will understand that the present invention can be implemented as other concrete forms without changing the inventive concept or essential features. Therefore, these embodiments as described above are only proposed for illustrative purposes and do not limit the present invention. It will be apparent to those skilled in the art that a variety of modifications and variations may be made without departing the spirit and scope of the present invention as defined by the appended claims. Further, such modifications and variations should not be understood independently from the technical idea or perspective of the present invention.

What is claimed is:

1. A hybrid electric toothbrush comprising:
a toothbrush body having an internal space;
a toothbrush head vibrating while being coupled to the upper portion of the toothbrush body to generate microcurrents;
a hybrid providing part built into the toothbrush body and transmitting vibration to the toothbrush head to form a magnetic field; and
a toothbrush cradle docking the toothbrush body to store the toothbrush body and providing charging power to the hybrid providing part.

2. The hybrid electric toothbrush according to claim 1, wherein the toothbrush head includes a plug, which is installed at the lower portion thereof, and to which the hybrid providing part is connected,
wherein the plug includes a through-groove into which the hybrid providing part is inserted and fixed,
wherein the toothbrush head includes: a ground electrode connected to a negative pole through the hybrid providing part; and an electrode spaced from the ground electrode and connected to a positive pole through the hybrid providing part to generate a magnetic field,
wherein the ground electrode is connected to a negative terminal connected to the negative pole of the hybrid providing part,
wherein the electrode is connected to a positive terminal connected to the positive pole of the hybrid providing part, and
wherein the negative terminal and the positive terminal are spaced apart from each other and fixed to the plug, and then are exposed through the through-groove.

3. The hybrid electric toothbrush according to claim 1, wherein the hybrid providing part includes:
a sonic motor generating ultrasonic vibration using input power;
a vibration shaft transmitting the vibration of the sonic motor;
a shaft connection part formed on the sonic motor to which the vibration shaft is connected;
a waterproof tube sealing between the vibration shaft and the shaft connection part watertightly;
a battery suppling power to the sonic motor;
a bracket embedded in the toothbrush body in the state in which the sonic motor and the battery are installed;
a charging coil charging the battery with power provided by the toothbrush cradle; and
a control unit controlling the sonic motor, controlling the charging of the charging coil, and controlling the charging power of the battery to form a magnetic field on the toothbrush head.

4. The hybrid electric toothbrush according to claim 1, wherein the bracket has locking wings formed at both sides thereof and inserted into the toothbrush body to be caught to the toothbrush body,
wherein the lower portion of the toothbrush body is blocked by a cap, and
wherein the cap has supports formed on both sides thereof to support the locking wings of the bracket.

5. The hybrid electric toothbrush according to claim 4, wherein the locking wings have locking jaws,
wherein the supports have locking grooves caught to the locking jaws, and
wherein when the cap blocks the toothbrush body in a state in which the locking jaws are caught to the locking grooves, the bracket is mounted on the toothbrush body.

6. The hybrid electric toothbrush according to claim 1, wherein the toothbrush cradle includes:
a toothbrush cradle body having an internal space opened upwards;
a toothbrush cradle cover closing the internal space of the toothbrush cradle body and holding the toothbrush body placed thereon;
a charging unit supplying charging power to the hybrid providing part embedded in the toothbrush body; and
a power cable supplying external power to the charging unit.

7. The hybrid electric toothbrush according to claim 1, wherein the toothbrush cradle cover has a concave mounting groove, an inclined surface getting narrower towards the lower portion thereof, and a flat bottom surface formed under the inclined surface.
